(19) United States
(12) Patent Application Publication
(10) Pub. No.: US 2017/0309972 A1
(43) Pub. Date: Oct. 26, 2017

(54) BATTERY SYSTEM

(71) Applicant: More Dot Cloud Creative Service Technology, Taoyuan City (TW)

(72) Inventor: Yen-Hsun PENG, Taoyuan City (TW)

(21) Appl. No.: 15/136,498

(22) Filed: Apr. 22, 2016

(51) Int. Cl. H01M 10/48; H01M 10/42

(52) U.S. Cl. CPC H01M 10/482; H01M 10/425; H01M 10/4207; H01M 2010/4278; H01M 2010/4271

(57) ABSTRACT

A battery system includes a plurality of batteries that generate operating information thereof, a server unit, an operation unit and a management unit. The server unit collects the operating information from the batteries, and provides the same altogether to the operation unit. The management unit receives the operating information from the operation unit to determine an operation condition of each of the batteries.

### FIELD

The disclosure relates to a battery system, and more particularly to a battery system having battery monitoring function.

### BACKGROUND

Rechargeable batteries are widely used in electric equipments to serve as power sources. However, battery capacity of the rechargeable batteries may be reduced due to frequent use. If users are not made aware of operating information of the rechargeable batteries, such as residual battery power, battery life time, etc., appropriate timing for fixing or replacing the batteries may be missed, and the electric equipments may thus stop operating or be damaged once the battery power runs out.

### SUMMARY

Therefore, an object of the disclosure is to provide a battery system that can monitor operating information of batteries thereof.

According to a first aspect of the disclosure, the battery system includes a plurality of batteries, a server unit, an operation unit and a management unit. Each of the batteries is configured to generate operating information thereof during operation, and to wirelessly transmit a battery signal that carries the operating information. The server unit is configured to wirelessly receive the battery signal transmitted by each of the batteries, to convert the battery signal transmitted by the batteries into a server signal that conforms to a predetermined format and that carries the operating information of the batteries, and to transmit the server signal. The operation unit is configured to receive the server signal from the server unit, and to convert the server signal into data that indicates the operating information of the batteries. The management unit is configured to receive the data from the operation unit, and to determine operation condition of each of the batteries according to the data thus received.

According to a second aspect of the disclosure, the battery system includes at least one primary battery and at least one auxiliary battery. Said at least one auxiliary battery is configured to generate operating information thereof during operation, and to wirelessly transmit an auxiliary battery signal that carries the operating information. Said at least one primary battery is configured to generate operating information thereof during operation, to wirelessly receive the auxiliary battery signal transmitted by said at least one auxiliary battery, and to generate a first primary battery signal that carries the operating information thereof and the operating information of said at least one auxiliary battery.

### BRIEF DESCRIPTION OF THE DRAWINGS

Other features and advantages of the disclosure will become apparent in the following detailed description of the embodiment(s) with reference to the accompanying drawings, of which:

FIG. 1 is a schematic block diagram illustrating a first embodiment of the battery system according to the disclosure; and

FIG. 2 is a schematic block diagram illustrating a second embodiment of the battery system according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

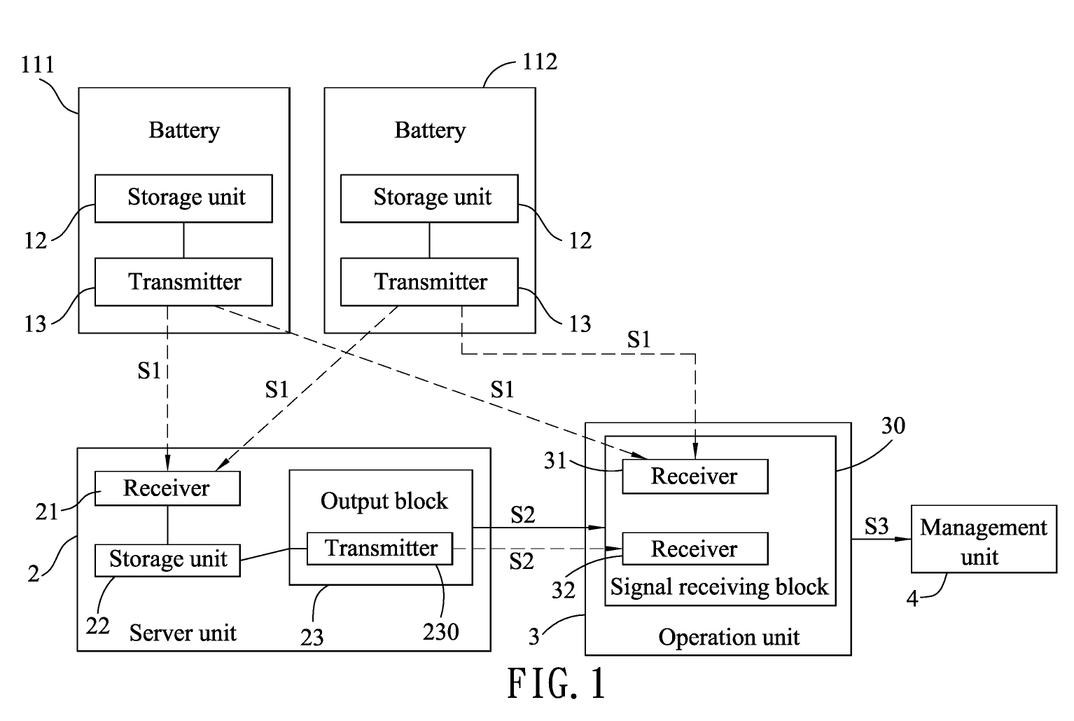

Referring to FIG. 1, the first embodiment of the battery system according to this disclosure is shown to include a plurality of batteries, a server unit 2, an operation unit 3 and a management unit 4.

In this embodiment, the batteries are exemplified using two batteries 111, 112, but the disclosure is not limited thereto. Each of the batteries 111, 112 generates operating information (not shown) thereof during operation, and includes a storage unit 12 to store therein the operating information, and a transmitter 13 coupled to the storage unit 12 for receiving therefrom the operating information, and wirelessly transmitting a battery signal (S1) that carries the operating information. In application, the batteries 111, 112 may be power sources installed in electrical equipments.

The batteries 111, 112 may be lead-acid batteries, silicic-acid batteries, etc., and the operating information of each of the batteries 111, 112 may be voltage information, current information, charge-discharge records, etc., but the disclosure is not limited thereto.

The server unit 2 includes a receiver 21, a storage unit 22 and an output block 23.

The receiver 21 wirelessly receives the battery signal (S1) transmitted by each of the batteries 111, 112, and demodulates the battery signal (S1) to obtain the operating information of each of the batteries 111, 112.

The storage unit 22 is coupled to the receiver 21 for receiving and storing therein the operating information of the batteries 111, 112.

The output block 23 is coupled to the storage unit 22 for receiving the operating information of the batteries 111, 112, generates a server signal (S2) that conforms to a predetermined format and that carries the operating information of the batteries 111, 112, and outputs the server signal (S2) using either a wired transmission protocol or a wireless transmission protocol. In the case of using the wireless transmission protocol, the output block 23 may include a transmitter 230 to wirelessly transmit the server signal (S2).

In application, the server unit 2 may be a device physically independent from the electrical equipments in which the batteries 111, 112 are installed, and dedicated to collect operating information from the batteries 111, 112. The server unit 2 may receive the battery signal (S1) from each of the batteries 111, 112, demodulate the battery signals (S1), and store the operating information of the batteries 111, 112 therein periodically every predetermined interval. The predetermined interval may be defined by users, and is between two and three hours in this embodiment.

Upon receipt of an instruction from a user, the operation unit 3 may issue a request for receiving operating information (not shown) to the server unit 2, such that the server unit 2 modulates the operating information of the batteries 111, 112 that is stored in the storage unit 22 into the server signal (S2), and transmits the server signal (S2). The operation unit 3 receives the server signal (S2) from the server unit 2, and converts the server signal (S2) into data (S3) that indicates the operating information of the batteries 111, 112. In one embodiment, the server unit 2 may actively transmit the server signal (S2) to the operation unit 3 without receiving from the operation unit 3 the request for receiving the operating information. The operation unit 3 includes a signal receiving block 30 to receive the server signal (S2) from the server unit 2. In the case where the server signal (S2) is wirelessly transmitted by the server unit 2, the signal receiving block 30 includes a receiver 32 for wirelessly receiving the server signal (S2). In this embodiment, the signal receiving block 30 further includes a receiver 31 that is able to wirelessly receive the battery signal (S1) of each of the batteries 111, 112. When a number of batteries that are configured as the batteries 111, 112 is smaller than or equal to a predetermined battery number, the operation unit 3 may obtain the operating information of the batteries by using the receiver 31 to directly receive and demodulate the battery signal (S1) transmitted individually by the batteries, instead of obtaining the operating information through the server signal (S2) transmitted by the server unit 2, but the disclosure is not limited thereto. As an example, when users sets the predetermined battery number to be one and the number of the battery is one, the battery may persistently store/update the operating information in the storage unit 12, and transmit the battery signal (S1) to the operation unit 3 upon receipt of the request for receiving operating information from the operation unit 3.

The management unit 4 receives the data (S3) from the operation unit 3, and determines an operation condition of each of the batteries 111, 112 according to the data (S3) thus received.

In detail, the management unit 4 may compare the operating information (e.g., current) of each of the batteries 111, 112 with a predetermined criterion, and determine whether or not the operating information satisfies the predetermined criterion. A negative determination may indicate that the battery under comparison is overused, and an affirmative determination may indicate that the battery is not overused.

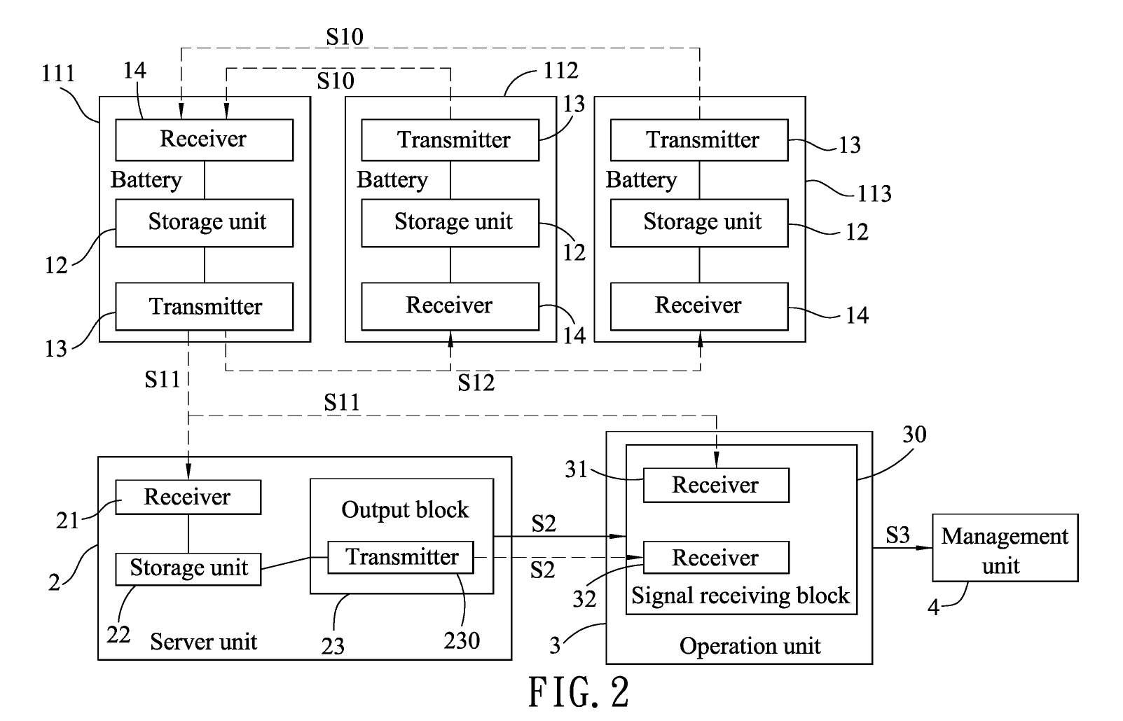

Referring to FIG. 2, the second embodiment of the battery system according to this disclosure is shown to differ from the first embodiment in that at least one battery may be selected to be a primary battery, and the other battery(ies) thus serves as an auxiliary battery(ies), while said at least one primary battery and the auxiliary battery(ies) may communicate wirelessly with each other for backup of the operating information. In this embodiment, the number of the batteries is three (i.e., there are the batteries 111, 112, 113), but the disclosure is not limited thereto. Each of the batteries 111, 112, 113 includes a storage unit 12, a transmitter 13 and a receiver 14. In application, for each of the batteries 111, 112, 113, the transmitter 13 and the receiver 14 may be fabricated within a chip that generates a chip signal. At an initialization stage, the server unit 2 may automatically detect intensity of the chip signal of each of the batteries 111, 112, 113, and determine at least one of the batteries 111, 112, 113 to be a primary battery according to the intensities of the chip signals thus detected, while the remaining battery(ies) serves as auxiliary battery(ies). In the embodiment of FIG. 2, the server unit 2 determines the battery 111 of which the intensity of the chip signal is the strongest to be the primary battery, and the batteries 112, 113 thus serve as auxiliary batteries. However, the disclosure is not limited to such application.

In this embodiment, each of the auxiliary batteries 112, 113 generates the operating information thereof during operation, and wirelessly transmits an auxiliary battery signal (S10) that carries the operating information thereof.

The primary battery 111 generates the operating information thereof during operation, wirelessly receives the auxiliary battery signals (S10) transmitted by the auxiliary batteries 112, 113, generates a first primary battery signal (S11) that carries the operating information thereof and the operating information of the auxiliary batteries 112, 113, and generates a second primary battery signal (S12) that only carries the operating information thereof.

Since the auxiliary batteries have the same configuration and operation amongst themselves, the auxiliary battery 112 is exemplified hereinafter for the sake of brevity, and the terms of “storage unit 12”, “transmitter 13” and “receiver 14” hereinafter refer to those of the auxiliary battery 112 if not particularly mentioned. The receiver 14 receives and demodulates the second primary battery signal (S12) transmitted by the primary battery 111 into the operating information of the primary battery 111. The storage unit 12 is coupled to the receiver 14, and stores therein the operating information of the corresponding auxiliary battery 112 and the operating information of the primary battery 111 which is obtained from the second primary battery signal (S12). The transmitter 13 is coupled to the storage unit 12, and wirelessly and periodically transmits the auxiliary battery signal (S10) to the primary battery 111.

In application, when the primary battery 111 is broken, the server unit 2 may detect the intensity of the chip signal of each of the remaining batteries 112, 113 anew, and determine the one of which the intensity of the chip signal is stronger to be the primary battery instead, while the operating information of the battery 111 prior to breakage of the battery 111 will not be lost since the storage units 12 of the batteries 112, 113 have stored therein the operating information of the battery 111 during the time that the battery 111 serves as the primary battery.

Hereinafter configuration and operation of the primary battery 111 is described, and the terms of “storage unit 12”, “transmitter 13” and “receiver 14” refer to those of the primary battery 111 if not particularly mentioned. The receiver 12 wirelessly receives the auxiliary battery signal (S10) transmitted by each of the auxiliary batteries 112, 113. The storage unit 12 is coupled to the receiver 14, and stores therein the operating information of the primary battery 111 and the operating information of each of the auxiliary batteries 112, 113 which is obtained from the auxiliary battery signals (S10). The transmitter 13 is coupled to the storage unit 12 for obtaining the operating information of the primary battery 111 and the auxiliary batteries 112, 113 therefrom, and wirelessly transmits the first primary battery signal (S11) converted from the operating information of the primary battery 111 and the auxiliary batteries 112, 113, and the second primary battery signal (S12) converted from the operating information of the primary battery 111.

The server unit 2 receives the first primary battery signal (S11) using the receiver 21, demodulates the first primary battery signal (S11) to obtain the operating information of the primary battery 111 and the auxiliary batteries 112, 113, and stores the operating information of the primary battery 111 and the auxiliary batteries 112, 113 into the storage unit 22.

The operation unit 3 and the management unit 4 of the second embodiment have configuration and operation the same as those of the first embodiment, and details thereof are not repeated herein for the sake of brevity. However, in one embodiment, the operation unit 3 may use the receiver 31 to directly receive and demodulate the first primary battery signal (S11) to obtain the operating information of the primary battery 111 and the auxiliary batteries 112, 113 instead of receiving the server signal (S2) from the server unit 2.

It is noted that, the battery system of this disclosure may further include a plurality of information-carrying members that are respectively disposed on the batteries, and a mobile information reader. Each information-carrying member may carry information related to the respective battery, such as lot number, manufacturing date, etc., in a format of, for example, QR code, but this disclosure is not limited to such. Users may use the mobile information reader to read the information carried by the information-carrying members, generate a reader signal carrying the information thus read, and wirelessly transmit the reader signal to the receiver 21, 31 of either one of the server unit 2 and the operation unit 3 for use in warranty or repair service.

In summary, the battery system of this disclosure may have the following advantages:

1. The operation unit 3 may obtain the operating information of the batteries through the server unit 2, thereby reducing work load of the operation unit 3. Nevertheless, users may also selectively cause the operation unit 3 to obtain the operating information directly from the batteries, thereby achieving higher efficiency.

2. In the second embodiment, since only the primary battery(ies) is used to transmit the operating information of ail batteries to either the server unit 2 or the operation unit 3, required data transmission outside of the batteries is reduced and simplified.

3. In the second embodiment, since the operating information of the primary battery(ies) may be stored in each of the auxiliary batteries as backup, when the primary battery(ies) becomes broken, monitoring of the batteries may continue normally without the operating information of the broken battery(ies) being lost by determining another one of the remaining batteries to serve as the primary battery.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A battery system comprising:
a plurality of batteries, each of which is configured to generate operating information thereof during operation, and to wirelessly transmit a battery signal that carries the operating information;
a server unit configured to wirelessly receive the battery signal transmitted by each of said batteries, to convert the battery signals transmitted by said batteries into a server signal that conforms to a predetermined format and that carries the operating information of said batteries, and to transmit the server signal;
an operation unit configured to receive the server signal from said server unit, and to convert the server signal into data that indicates the operating information of said batteries; and
a management unit configured to receive the data from said operation unit, and to determine an operation condition of each of said batteries according to the data thus received.

2. The battery system of claim 1, wherein each of said batteries includes:
a storage unit configured to store therein the operating information;
a transmitter coupled to said storage unit, and configured to wirelessly transmit the battery signal.

3. The battery system of claim 1, wherein the predetermined format to which the server signal conforms complies with one of a wireless transmission protocol and a wired transmission protocol.

4. The battery system of claim 1, wherein said management unit is configured to determine whether or not the operating information of each of said batteries satisfies a predetermined criterion.

5. The battery system of claim 1, wherein said server unit includes:
a first receiver configured to wirelessly receive and demodulate the battery signal transmitted by each of said batteries to obtain the operating information of each of said batteries; and
a storage unit coupled to said first receiver for receiving the operating information of each of said batteries therefrom, and configured to store therein the operating information of each of said batteries;
wherein said server unit is configured to modulate the operating information of said batteries that is stored in said storage unit into the server signal, and to transmit the server signal to said operation unit when said operation unit issues a request for receiving operating information to said server unit.

6. The battery system of claim 5, wherein said server unit further includes a transmitter configured to wirelessly transmit the server signal, and said operation unit includes a second receiver configured to wirelessly receive the battery signal transmitted by each of said batteries, and a third receiver configured to wirelessly receive the server signal transmitted by said server unit.

7. A battery system comprising:
at least one auxiliary battery configured to generate operating information thereof during operation, and to wirelessly transmit an auxiliary battery signal that carries the operating information; and
at least one primary battery configured to generate operating information thereof during operation, to wirelessly receive the auxiliary battery signal transmitted by said at least one auxiliary battery, and to generate a first primary battery signal that carries the operating information thereof and the operating information of said at least one auxiliary battery.

8. The battery system of claim 7, wherein said at least one primary battery includes:
a receiver configured to wirelessly receive the auxiliary battery signal transmitted by said at least one auxiliary battery;
a storage unit coupled to said receiver, and configured to store therein the operating information of said at least one primary battery and said at least one auxiliary battery; and
a transmitter coupled to said storage unit, and configured to wirelessly transmit the first primary battery signal.

9. The battery system of claim 7, wherein said at least one primary battery is configured to generate a second primary battery signal that carries the operating information thereof, and to transmit the second primary battery signal to said at least one auxiliary battery.

10. The battery system of claim 9, wherein said at least one auxiliary battery includes:
a receiver configured to receive the second primary battery signal from said at least one primary battery;
a storage unit coupled to said receiver, and configured to store therein the operating information of said at least one auxiliary battery and the operating information of said at least one primary battery; and
a transmitter coupled to said storage unit, and configured to wirelessly transmit the auxiliary battery signal.

11. The battery system of claim 7, further comprising:
a server unit configured to wirelessly receive the first primary battery signal, to convert the first primary battery signal into a server signal that conforms to a predetermined format and that carries the operating information of said at least one primary battery and said at least one auxiliary battery, and to transmit the server signal;
an operation unit configured to receive the server signal from said server unit, and to convert the server signal into data that indicates the operating information of said at least one primary battery and said at least one auxiliary battery; and
a management unit configured to receive the data from said operation unit, and to determine an operation condition of each of said at least one primary battery and said at least one auxiliary battery according to the data thus received.

12. The battery system of claim 11, wherein said at least one primary battery includes:
a receiver configured to wirelessly receive the auxiliary battery signal transmitted by said at least one auxiliary battery;
a storage unit coupled to said receiver, and configured to store therein the operating information of said at least one primary battery and said at least one auxiliary battery; and
a transmitter coupled to said storage unit, and configured to wirelessly transmit the first primary battery signal.

13. The battery system of claim 11, wherein the predetermined format to which the server signal conforms complies with one of a wireless transmission protocol and a wired transmission protocol.

14. The battery system of claim 11, wherein said at least one primary battery is configured to generate a second primary battery signal that carries the operating information thereof, and to transmit the second primary battery signal to said at least one auxiliary battery.

15. The battery system of claim 14, wherein said at least one auxiliary battery includes:
a receiver configured to receive the second primary battery signal from said at least one primary battery;
a storage unit coupled to said receiver, and configured to store therein the operating information of said at least one auxiliary battery and the operating information of said at least one primary battery; and
a transmitter coupled to said storage unit, and configured to wirelessly transmit the auxiliary battery signal.

16. The battery system of claim 11, wherein said management unit is configured to determine whether or not the operating information of each of said at least one primary battery and said at least one auxiliary battery satisfies a predetermined criterion.

17. The battery system of claim 11, wherein said server unit includes:
a first receiver configured to wirelessly receive and demodulate the first primary battery signal transmitted by said at least one primary battery to obtain the operating information of said at least one primary battery and said at least one auxiliary battery; and
a storage unit coupled to said first receiver for receiving the operating information of said at least one primary battery and said at least one auxiliary battery therefrom, and configured to store therein the operating information of said at least one primary battery and said at least one auxiliary battery;
wherein said server unit is configured to modulate the operating information of said at least one primary battery and said at least one auxiliary battery that is stored in said storage unit into the server signal, and to transmit the server signal to said operation unit when said operation unit issues a request of receiving operating information to said server unit.

18. The battery system of claim 11, wherein said server unit includes a transmitter configured to wirelessly transmit the server signal, and said operation unit includes a first receiver configured to wirelessly receive the first primary battery signal transmitted by said at least one primary battery, and a second receiver configured to wirelessly receive the server signal transmitted by said server unit.
